(19) United States
(12) Patent Application Publication
(10) Pub. No.: US 2018/0176638 A1
(43) Pub. Date: Jun. 21, 2018

(54) LANGUAGE-BASED SIGNALING OF SECONDARY AUDIO

(71) Applicant: ARRIS Enterprises LLC, Suwanee, GA (US)

(72) Inventors: Dinkar N. Bhat, Princeton, NJ (US); Patrick J. Leary, Horsham, PA (US)

(21) Appl. No.: 15/381,046

(22) Filed: Dec. 15, 2016

(51) Int. Cl. H04N 21/439; G10L 25/78; G10L 15/26; G10L 15/02; G10L 15/00; G10L 25/51; G10L 19/00; H04N 21/81; H04N 21/4147; H04N 21/4363

(52) U.S. Cl. CPC H04N 21/4394; G10L 25/78; G10L 15/26; G10L 15/02; G10L 15/005; H04N 21/4884; G10L 19/00; H04N 21/8106; H04N 21/4147; H04N 21/43635; G10L 25/51

(57) ABSTRACT

An actual language contained within a compressed digital A/V stream within an MPEG-2 (or HDMI) stream is detected upon program transition by monitoring the actual audio content of a currently selected audio stream within the MPEG-2 (or HDMI or MP4) stream. The monitored audio stream is converted in real time to text. A frequency of sequence of three letters (a trigram) in the converted text is generated, and a plurality of the most frequent trigrams within the converted text are retained. An actual language being spoken is detected in the digital audio stream by determining a closest match between the retained plurality of trigrams and a pre-stored entry in a list of most frequent trigrams (MFT) each pre-associated with a given respective language. The detected actual language may be compared to an ISO language descriptor received in the stream, and appended to an AC-3 audio coding descriptor.

### BACKGROUND OF THE INVENTION

### 1. Field of the Invention

The present invention relates to reliable and accurate signaling of a secondary audio channel received by a set-top box or HDMI sink device such as a television or DVR.

### 2. Background of Related Art

Digital TV is transmitted as a stream of MPEG-2 data known as a transport stream. Each transport stream has a data rate of up to 40 mb/s for a cable or satellite network, which is enough for seven or eight separate TV channels, or about 25 mb/s for a terrestrial network.

Each transport stream includes a multiplexed set of sub-streams known as elementary streams. Each elementary stream can contain MPEG-2 encoded audio, MPEG-2 encoded video, or data encapsulated in an MPEG-2 stream. Each elementary stream has a unique 13-bit ‘packet identifier’ (PID) that identifies that stream within the transport system.

Each MPEG-2 elementary stream is packetized into a packetized elementary stream (PES). Each packetized elementary stream (PES) is packetized again into 188 byte transport packets. Transport packets are much smaller than PES packets. A ratio of ten video packets to every one audio packet is typical.

MPEG and digital video broadcasting (DVB) both specify data known as ‘service information’ relating to what is contained in the elementary streams within the transport stream. Each service in a transport stream includes one video channel and one mono, stereo, or surround sound audio track. The service information is added to the transport stream during multiplexing. Teletext or other non-AV data may be included in private sections of MPEG transport packets.

Service information is a simple database that describes the structure of the transport stream. Basically it contains a number of tables that each describe one service in the transport stream. These tables list each elementary stream in the service and provide its PID and the type of data contained in the elementary stream.

FIG. 7 depicts a conventional digital video broadcasting (DVB) transport stream.

In particular, as shown in FIG. 7, the transport stream 1010 may contain more than one service, with all the audio, video and data streams for all the services multiplexed together. The service information describes which elementary stream belongs to which service, and includes additional information such as channel names and descriptions, TV program schedule, parental ratings, etc.

FIG. 8 shows a conventional transport stream.

In particular, as shown in FIG. 8, an exemplary transport stream 1110 contains eight elementary streams 100, 101, 102, 200, 201, 202, 203, 204 split across two services 1112, 1114. The elementary streams with PIDs 100, 200 and 201 contain video, while the other elementary streams 101, 102, 202, 203 contain audio tracks in different languages. The elementary stream with PID 204 contains a multimedia home platform (MHP) application. When there are multiple audio tracks then there are several different elementary streams with other PIDs.

Service information tables that are commonly included in a DVB service include a program map table (PMT), which is defined in an MPEG-2 standard. The program map table (PMT) is the table that actually describes all elementary streams in a given service.

The MPEG-2 standard, which covers the generic coding of moving pictures and ISO/IEC 13818, is well known to those of ordinary skill in the art, and thus need not be repeated herein. The MPEG-2 standard is expressly incorporated herein by reference in its entirety.

A digital channel may, and frequently does, include a second audio elementary stream, with its own packet identifier (PID). The second audio elementary stream in a digital channel is used to transmit audio either in a secondary language (such as Spanish), or in Descriptive Video Service (DVS) audio (such as English). The second audio elementary stream is often referred to as a second audio program (SAP).

FIG. 9 shows a conventional HDMI sink device such as a television connected to a set-top box that delivers a selected video and/or audio program to the television.

In particular, as shown in FIG. 9, a set-top box 904 is connected to cable service equipment in association with a cable headend (not shown). While the invention is shown and described with respect to a cable headend, the invention relates equally to streaming services from an Internet source.

The set-top box 904 includes an HDMI interface 907, through which the set-top box 904 communicates with an HDMI sink device such as a television 902 over an HDMI cable 906 connecting the HDMI interface 907 in the set-top box 904 to an HDMI interface 917 in the HDMI sink device 902. A user instructs the set-top box 904, through a visual display on the television 902 and infrared or wireless remote control (not shown), to play secondary audio provided with any or all media programs.

With media programs, an ISO language descriptor is included in a service information message to provide meta-data to a receiver to permit intelligent selection of audio via a graphical user interface of the set-top box 904. Set-top boxes 904 in the US typically provide a language option to the user (e.g., “Spanish”) to select a secondary audio elementary stream associated with a selected program.

Thus, when a viewer selects secondary audio on a particular channel transmitted by the set-top box 904 over its HDMI interface 907 to an HDMI sink device such as the television 902, the television 902 may receive Spanish language audio—or DVS depending on what is being transmitted. If neither a secondary audio elementary stream or DVS audio is being transmitted in the service, the set-top box 904 automatically switches back to the main audio elementary stream provided with the selected program.

However, as the inventors hereof appreciated, this automatic switching of played audio back to a main audio elementary stream can occur upon events such as channel transitions (a change of channel), a change of program from one program to the next (e.g., at the top of the hour, etc.) Or the selected audio channel may change for other reasons, which the present inventors have appreciated may be confusing or distracting to the viewer of the HDMI sink device, e.g., a television 902. Adding to the confusion is that a broadcaster may signal an audio elementary stream as generically containing “original audio” language, without specifying the exact language being used, thus making automatic selection of the proper audio channel unreliable at best, or at worst not always possible.

An AC-3 descriptor may also be included in a program map table (PMT) to identify elementary streams which carry AC-3 audio. An Enhanced AC-3 descriptor may also be included to identify elementary streams that have been coded with Enhanced AC-3 audio coding. Other optional fields in the descriptor may be used to provide identification of the component type mode of the AC-3 audio coded in the stream, and indicate if the elementary stream is a main AC-3 audio service (main field) or an associated AC-3 service (ASVC field).

The present inventors have appreciated that although the Consumer Electronics Association (CEA)'s method of signaling DVS through the AC-3 descriptor is now standardized, many digital channels are still deployed with audio being signaled solely through use of the ISO language descriptor. The inventors have appreciated that many existing legacy set-top boxes at best detect only the data within an ISO language descriptor, and not the content of the AC-3 descriptor. As explained above, the inventors have appreciated that use of the ISO language descriptor for automatic selection of audio channel is unreliable at best, and not always possible at worst.

### SUMMARY OF THE INVENTION

In accordance with the principles of the present invention, a method of detecting an actual language contained within a digital audio stream within an MPEG-2 (or HDMI) stream, comprises monitoring the actual audio content of a currently selected audio stream within the MPEG-2 (or HDMI) stream. The monitored audio stream is converted in real time to text. A frequency of sequence of three letters (a trigram) in the converted text is generated, and a plurality of the most frequent trigrams within the converted text are retained. An actual language being spoken is detected in the digital audio stream by determining a closest match between the retained plurality of trigrams and a prestored entry in a list of most frequent trigrams (MFT) each pre-associated with a given respective language.

In another aspect, a non-transitory computer-readable medium comprises instructions stored thereon for detecting an actual language contained within a digital audio stream within an HDMI stream, that when executed on a processor, to perform the steps of monitoring the actual audio content of a currently selected audio stream within the HDMI stream; converting the monitored audio stream in real time to text; generating a frequency of sequence of three letters (a trigram) in the converted text, and retaining a plurality of most frequent trigrams within the converted text; and detecting an actual language being spoken in the digital audio stream by determining a closest match between the retained plurality of trigrams and a prestored entry in a list of most frequent trigrams (MFT) each pre-associated with a given respective language.

### BRIEF DESCRIPTION OF THE DRAWINGS

Features and advantages of the present invention will become apparent to those skilled in the art from the following description with reference to the drawings, in which:

FIG. 1 shows a set-top box including an actual language detection module for controlling reliable selection and control of secondary audio program, in accordance with the principles of the present invention.

FIG. 2 shows details of an actual language detection module in the set-top box of FIG. 1.

FIG. 3A is a flow diagram of reliably detecting an actual language spoken in a selected audio channel by monitoring the secondary audio itself, in accordance with the principles of the present invention.

FIG. 3B is a flow diagram of reliably detecting an actual language spoken in a selected audio channel by monitoring received closed captioning, in accordance with the principles of the present invention.

FIG. 4 shows another embodiment of a set-top box including an actual language detection module that detects an actual language being spoken in two audio channels of a selected program, and alternatively or additionally the text of received closed captioning, in accordance with the principles of the present invention.

FIG. 5 shows details of another embodiment of an actual language detection module in the set-top box of FIG. 4.

FIG. 6 shows an embodiment of an HDMI sink device such as a television including an actual language extractor and an actual language detector to alert a user of the HDMI sink device of an actual language being received, in accordance with the principles of the present invention.

FIG. 7 depicts a conventional digital video broadcasting (DVB) transport stream.

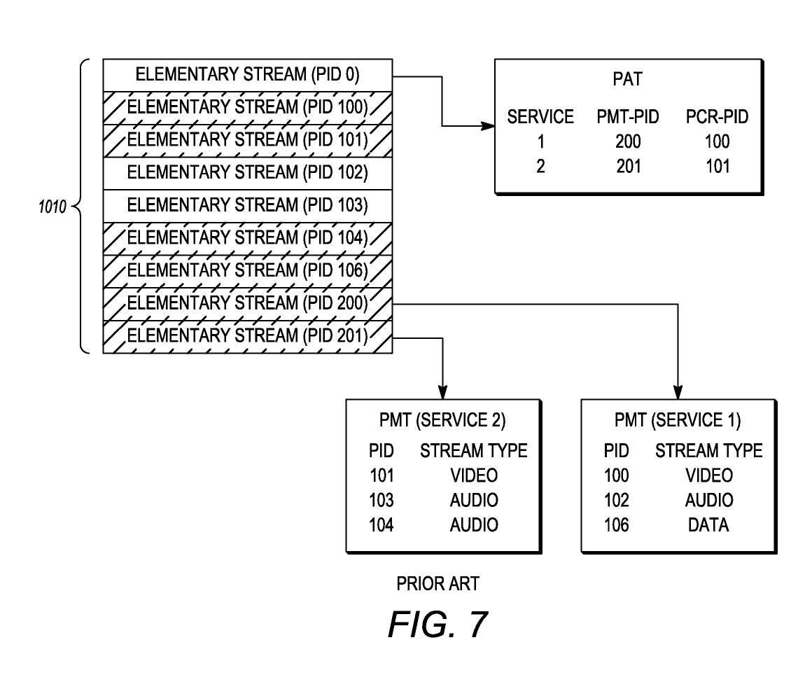

FIG. 8 shows a conventional transport stream.

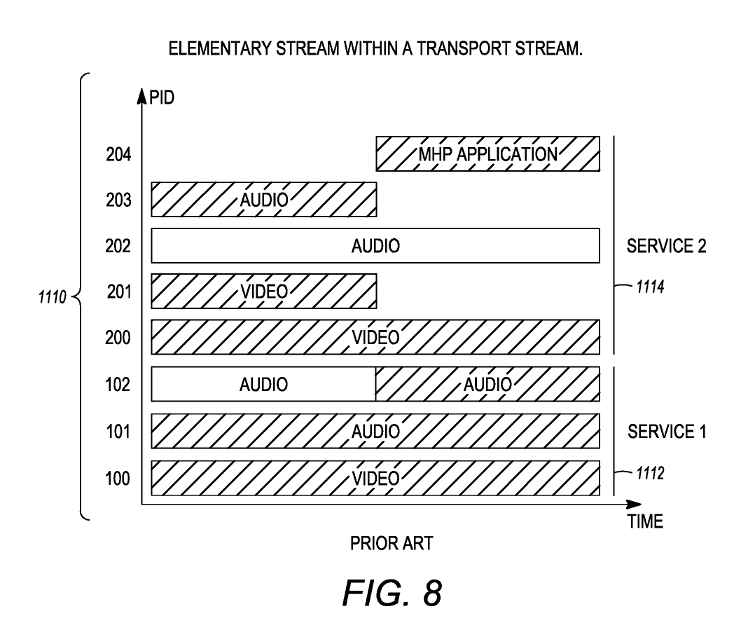

FIG. 9 shows a conventional HDMI sink device such as a television connected to a set-top box that delivers a selected video and/or audio program to the television.

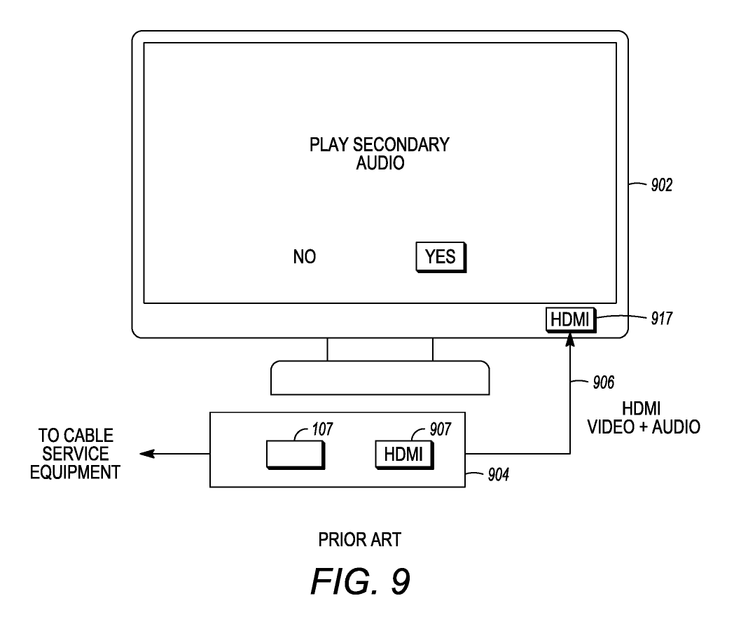

### DETAILED DESCRIPTION

The present invention determines and corrects signaling mismatch in secondary audio based on the actual content of the audio in the secondary audio channel. Disclosed embodiments relate to use in a set-top box (or Home Network End Device “HNED”), but the principles apply equally to use within a user HDMI sink device such as a television or digital video receiver (DVR).

The invention alleviates problems in conventional use of an ISO language descriptor, particularly observed by the inventors hereof, to automatically detect the textually named language contained in an associated audio stream. Use of an ISO language descriptor has conventionally been felt to provide reliable language identification.

The inventive system and method additionally, or instead, monitors the actual audio content of the currently selected audio channel, converts the audio in real time to text, and based on the first few or so detected words determines a most probable actual language of the audio. The receiving device (e.g., set-top box, or HDMI sink device) is then alerted to the actual language detected despite the textual content in the ISO language descriptor.

Detection of the actual language contained in the content of the audio stream is preferably accomplished within the first few audible words received in a given selected audio stream. This enables a receiver device, e.g., a set-top box, or HDMI sink device such as a television or DVR, via appropriate hardware and software elements, to appropriately and reliably manage the viewer experience.

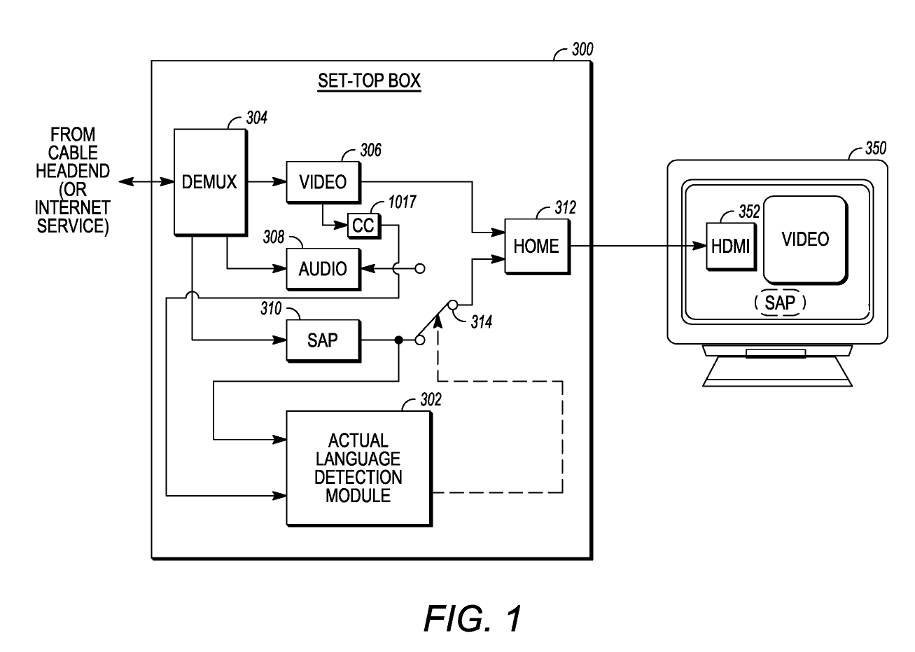

FIG. 1 shows a set-top box including an actual language detection module for controlling reliable selection and control of secondary audio program, in accordance with the principles of the present invention.

In particular, as shown in FIG. 1, a set-top box 300 includes an HDMI interface 312, which is connected to a mating HDMI interface 352 in an appropriate HDMI sink device such as a television 350. The set-top box 300 receives a transport stream from a cable headend or Internet service. A demultiplexer 304 in the set-top box 300 demultiplexes the contents of the received transport stream, and provides a selected video stream 306 to the HDMI interface 312 for transmission to the HDMI sink device 350 over the HDMI interface 312, 352.

In the shown example of FIG. 1, the video 306 is associated with two audio streams; audio stream 308 and secondary audio program (SAP) 310. Importantly, an actual language detection module 302 receives the secondary audio program (SAP) digital audio stream 310. Depending upon the detected actual language contained within the SAP digital audio stream 310, and a specific language selection set within the set-top box 300, the actual language detection module 302 automatically controls direction (depicted schematically with a relay 314) either of the main audio stream 308 or the SAP audio stream 310 to the HDMI interface 312 for playback along with the associated video stream 306 also directed to the HDMI interface 312.

While the invention shows detection by the actual language detection module 302 of the actual language of a SAP audio stream 310, it is equally applicable to detection of an actual language within the main audio stream 308.

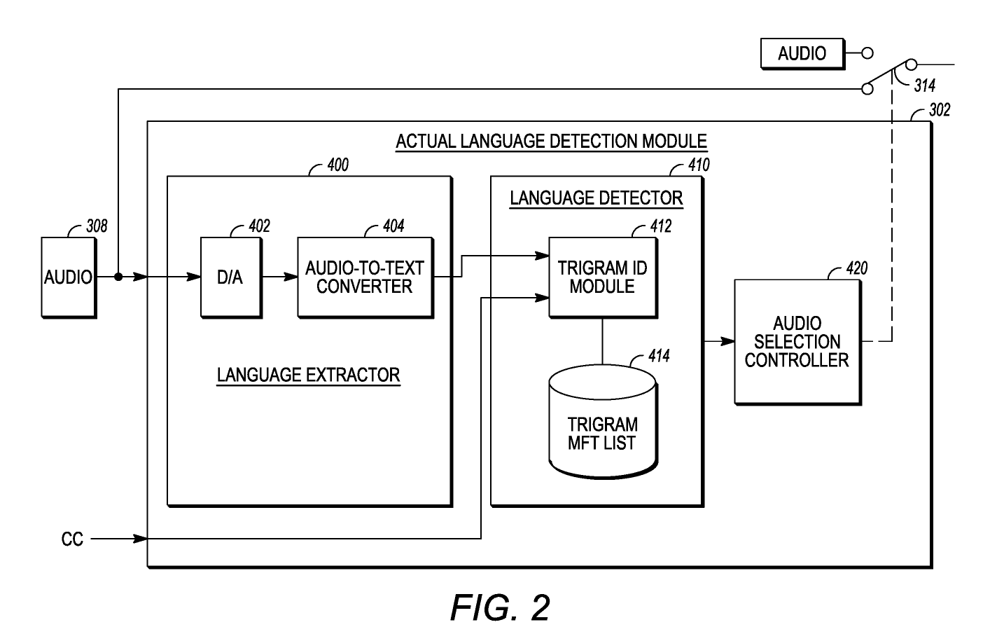

FIG. 2 shows details of an actual language detection module in the set-top box of FIG. 1.

In particular, as shown in FIG. 2, an exemplary actual language detection module 302 includes a language extractor 400, a language detector 410, and an audio selection controller 420. The language extractor 400 receives the digital audio stream, e.g., from the SAP 310. The language extractor 400 converts the input digital audio stream into an analog audio stream using an appropriate codec and digital-to-analog converter (D/A) 402, to produce an analog audio component. The analog audio is input to an appropriate audio-to-text converter 404. The language extractor 400 ultimately outputs textual words to a language detector 410.

The language detector module 410 is an important element of the present invention. The audio data in the received media stream (e.g., audio data in the second audio program (SAP) channel) is passed to the language detector module 410. The language detector module 410 identifies the actual language using a trigram method.

The language detector 410 comprises a trigram identification (ID) module 412 and a database containing a trigram MFT (most frequent trigram) list 414. The language detector 410 determines an actual language being spoken within the audio stream that is input to the actual language detection module 302, and outputs instruction to an audio selection controller 420 to cause selection between the main audio 308 and the secondary audio program (SAP) 310, as depicted by actual or virtual relay 314. If the secondary audio program (SAP) does not contain any spoken words (e.g., it contains only music) within a certain time period, then the language detector 410 exits gracefully.

On program transition or channel tuning, the secondary audio is passed through the actual language detection module 302. Program transition, or boundaries, may be detected from EPG metadata either broadcast in the stream or obtained out-of-band.

The language extractor module 400 extracts the text through so an appropriate speech-to-text converter (audio-to-text converter) 404, and either the speech-to-text extracted text, or closed caption text extracted from the video 306, is injected into a language detector module 410 to determine the language through a trigram identification (ID) module 412. The trigram ID module 412 passes the identity of the detected language to the receiver application. The receiver application compares the identity of the detected language to the language signaled (in the ISO Language descriptor).

Ideally, the ISO Language descriptor should contain the proper identity of the language. However, that is an ideal situation; real life situations are different. Moreover, in the case of an ISO language descriptor of “original audio”, the identity of the actual language is not provided.

If the identity of the detected language does not match the ISO Language descriptor, then the application is provided with the capability to alert the viewer in any appropriate manner, e.g., using an on screen drop-down box, a viewable confirmation screen, etc.

In some instances the AC-3 audio coding descriptor is missing. In the case where the AC-3 audio coding descriptor is missing, AC-3 descriptor information may be appended in the memory to the program map table (PMT) so that if/when the media is recorded, the recorded program will subsequently contain appropriate AC-3 descriptor information in the form of a new, locally stored AC-3 descriptor indicating the proper language.

The present invention utilizes a trigram model for language detection in a secondary audio channel, preferably upon the start of a new media program (e.g., a new movie, TV show, etc.), and/or upon the change of a streaming channel (e.g., changing the channel at the set-top box).

In accordance with the invention, the audio component in a secondary audio channel of a media program received at a set-top box 300 (e.g., from a cable headend, from a DVR, etc.) is processed by an audio-to-text converter 404. The trigram model for language detection of a given sentence is then used.

The frequency of sequence of three letters (trigram) in a large corpus for a given language is determined, and the most frequent trigrams are retained. This is performed offline and once. It may be refined but is preferably updated occasionally. During language detection, the trigrams in a new sentence are compared with the most frequent trigram lists of each language to guess the language.

The first stage is finding the probabilities of trigrams in a given corpus for each language expected (e.g., English, Spanish, etc.) This is an offline process in disclosed embodiments. For determining the probabilities of trigrams from a large collection of documents in a specific language, each sentence is tokenized using space as the separator. An underscore is added to initial and terminal bigrams. As an example in the sentence “quick fox” in English, the trigrams are “_qu”, “qui”, “uic”, “ick”, “ck_”, “k_f”, “_fo”, “fox”, “ox_”. All trigrams are counted, and the most frequent trigrams based on a predetermined threshold are retained. The probability of any trigram is therefore=(frequency of the trigram)/(sum of frequency of all trigrams retained). Obviously, the most common ones have higher frequency. Note that this process is done one time over a large set of documents relevant to the domain (in the disclosed embodiments a given broadcast). The probabilities may be updated if a better broadcast is determined (e.g., a news program versus a sports event). The retained set of trigrams along with the probabilities is called the “most frequent trigram” (MFT) list for that particular language.

During the language detection stage, given a sentence (extracted from audio-to-text conversion 404), the same tokenization as described above is performed and then the tokens are compared with the MFT for each language expected or otherwise desired to be included. For each language, the probability of any given sentence being identified as a given language is the product of the probabilities of each contained trigram in the most frequent trigram (MFT) list. The language that corresponds to the highest computed probability is selected as the detected language for that audio.

Once the language of the secondary audio is detected, a matching module in the receiver application compares the detected language with the language signaled in the ISO language descriptor. If they do not match, then an alert may be thrown which can then be appropriately handled by the receiver application (for instance, displaying the actual language or even turning back to the main audio). Also, if the AC-3 descriptor is missing in the program map table (PMT) of the program specific information (PSI), the missing AC-3 descriptor is preferably added in memory for the program map table (PMT). The aim is that when a given program is recorded to digital video recorder (DVR), the correct PMT would be stored with the program in the DVR and used on subsequent playback (e.g., to a television or the like.)

The language detection process is preferably performed quickly. That is, it should be capable of detecting the language of audio ideally within a first given number of detected words. For instance, in one embodiment within the first three detected words. Of course, the invention relates equally to detection of the language in the audio channel within more than three words, particularly where there are a significant number of possible languages to choose from, and particularly where increased reliability in language detection is desired.

The language detection module runs only at program boundaries, that is, at the start of any given movie, show, etc., or tuning to a new channel.

Advertisements are usually absent the secondary audio, thus the set-top box (STB) may automatically shift to the main audio (often English). If there is secondary audio with a given advertisement, and if the start of an advertisement is detected with an “ad detection” system, then the invention may be utilized at the start of an advertisement to detect the language of the secondary audio for that advertisement.

The particular model audio-to-text conversion used is not as important as it being reliable. Currently there are many open source implementations of audio-to-text conversion that are lightweight and reliable.

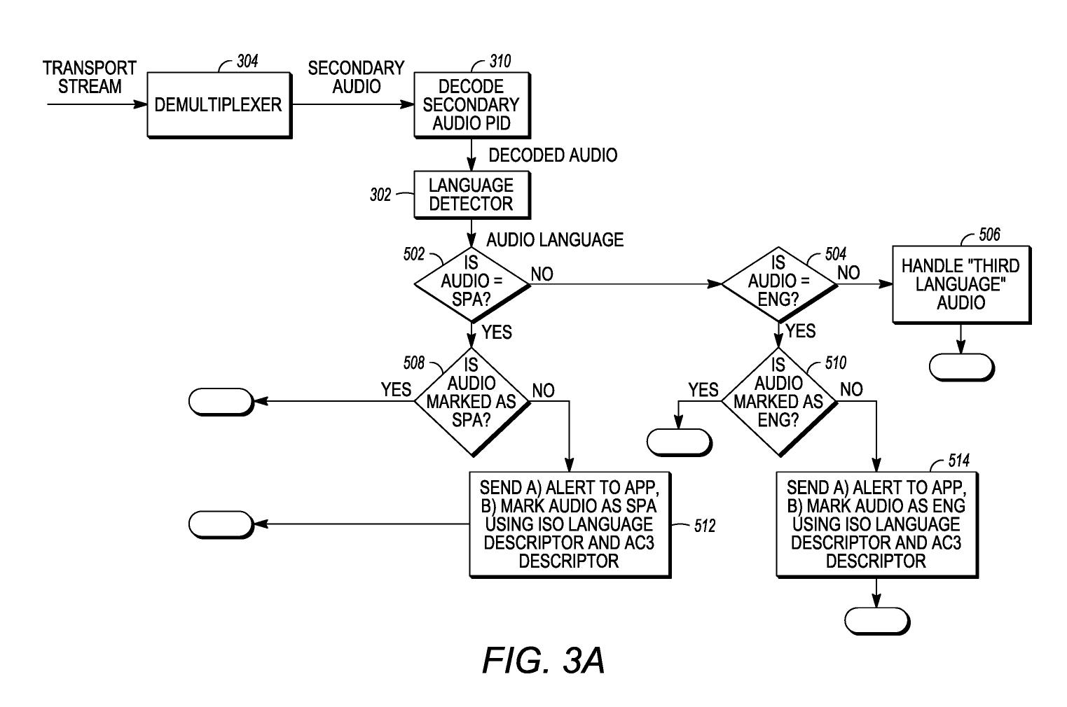

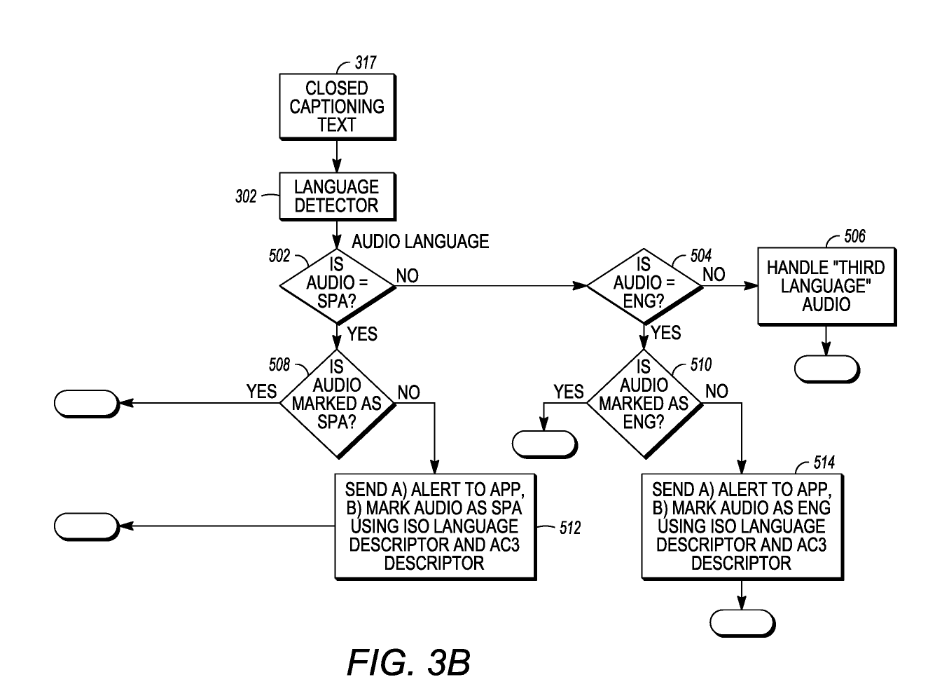

FIG. 3A is a flow diagram of reliably detecting an actual language spoken in a selected audio channel by monitoring the secondary audio itself, in accordance with the principles of the present invention.

In particular, as shown in FIG. 3A, a transport stream is demultiplexed in step 304, to isolate a secondary audio program (SAP) contained within the transport stream.

The secondary audio PID is decoded in step 310.

In step 302, the language detector 410 detects the specific language contained within the SAP based on the content of the audio itself.

In step 502, the identity of the detected language is determined if it is, e.g., Spanish. If yes, then in step 508 it is determined if the audio is already marked as Spanish. If the language was already marked as being Spanish, then the process ends. If instead the detected language was determined to be Spanish, but the audio was not marked as Spanish, then the process moves to step 512 to send a) an alert to the app that the detected language is different from the expected language, and b) mark the audio as Spanish using the ISO language descriptor and the AC-3 descriptor.

If back at step 502 the detected language was determined not to be Spanish, then in step 504 it is determined if the detected language is English. If the detected language is not English, then the process moves to step 506 where an additional (third) language option beyond Spanish or English is handled. If instead the detected language is determined in step 504 to be English, the process moves to step 510 to determine if the audio is already marked as being English. If it is, then the process ends. If the detected language is English but the audio was not marked as English, the process moves from step 510 to step 514 to send a) Alert to app, and b) to mark the audio as English using the ISO language descriptor and the AC-3 descriptor.

FIG. 3B is a flow diagram of reliably detecting an actual language spoken in a selected audio channel by monitoring received closed captioning, in accordance with the principles of the present invention.

CEA-708-B defines the coding of DTVCC (“708 closed captioning.) The captioning data is carried in the video user bits of the MPEG-2 bistream. 708 captions are place into MPEG-2 video streams in the picture user data. The digital system allocates a data rate of 9600 bps for closed captioning use, which is ten times as much capacity as in the NTSC system and opens up the capability to offer various caption services within a caption channel with varied text characteristics, multi-colors, more language channels and many other features. Caption appearance, and other characteristics, are controllable by the viewer at home.

The HD-SDI closed caption and related data is carried in three separate portions of the HD-SDI bitstream: in the Picture User Data, the Program Mapping Table (PMT), and the Event Information Table (EIT). The caption text and window commands are carried in the HD-SDI Transport Channel (which in turn is carried in the Picture User Bits). The HD-SDI Caption Channel Service Directory is carried in the PMT and optionally for cable in the EIT.

The process of FIG. 3B is similar to that of FIG. 3A, except that instead of monitoring the actual secondary audio channel and converting audio to text, closed captioning text is extracted from the video stream 306 as shown in FIG. 1 using a suitable captioning extraction device 1017 (e.g., a digital closed captioning decoder if required). Thus, as shown in step 317 of FIG. 3B, closed captioning text is extracted from the video stream 306 and fed directly into the actual language detection module 302. Otherwise, the process of FIG. 3B flows the same as shown and described with respect to FIG. 3A.

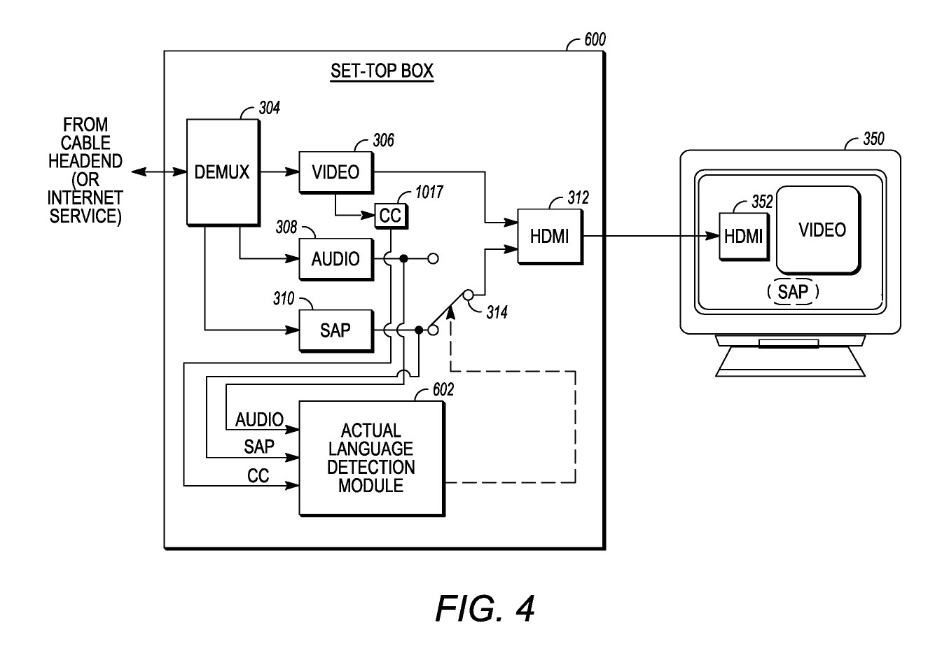

FIG. 4 shows another embodiment of a set-top box including an actual language detection module that detects an actual language being spoken in two audio channels of a selected program, and alternatively or additionally the text of received closed captioning, in accordance with the principles of the present invention.

In particular, as shown in FIG. 4, another embodiment of a set-top box 600 is shown that includes an actual language detection module 602 that monitors the actual language being spoken in both a primary audio channel 308, and a secondary audio program 310. Moreover, the actual language detection module 602 further monitors the text received in a closed captioning extracted from the video stream 306.

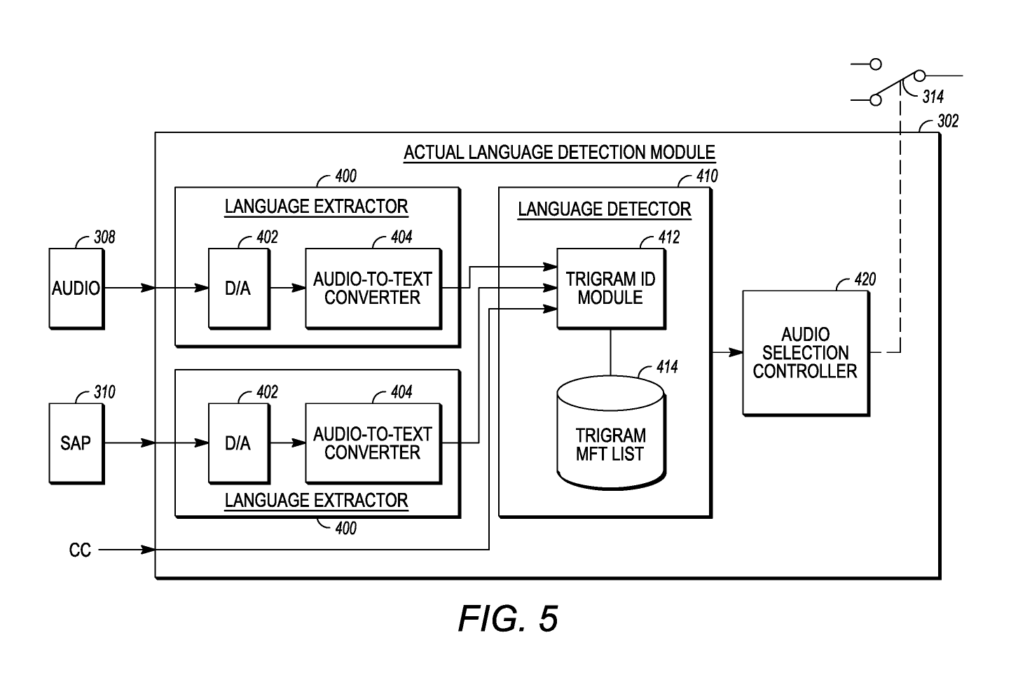

FIG. 5 shows details of another embodiment of an actual language detection module in the set-top box of FIG. 4.

In particular, as shown in FIG. 5, another embodiment of an exemplary actual language detection module 602 includes two language extractors 400, at least one instance of a language detector 410 if multiplexed for use by both language extractors 400 and input captioning text (as shown in FIG. 5).

Alternatively three separate language detectors 410 may be implemented, one for the primary audio 308, a second for the secondary audio 310, and a third for the closed captioning text. The actual language detection module 302 further includes an audio selection controller 420 to control selection of the audio source output to the receiving device (e.g., to the HDMI interface 312.)

The first language extractor 400 receives the digital audio stream, e.g., from the primary audio 308. The first language extractor 400 converts the input digital audio stream into an analog audio stream using an appropriate codec and digital-to-analog converter (D/A) 402, to produce an analog audio component. The analog audio is input to an appropriate audio-to-text converter 404. The first language extractor 400 ultimately outputs textual words actually being spoken within the primary audio 308 to the language detector 410.

Similarly, the second language extractor 400 receives the digital audio stream, e.g., from the secondary audio 310. The second language extractor 400 converts the input digital audio stream into an analog audio stream using an appropriate codec and digital-to-analog converter (D/A) 402, to produce an analog audio component. The analog audio is input to an appropriate audio-to-text converter 404. The second language extractor 400 ultimately outputs textual words actually being spoken within the secondary audio 310 to the language detector 410.

In an alternative functionality, text from received closed captioning may be input to the language detector 410. Note that if received closed captioning is monitored, one (or even both) language extractors 400 may be eliminated.

The actual language detection module 602 then directs one of the two audio streams 308, 310 to the appropriate output interface (e.g., to the HDMI interface 312), as depicted by a virtual relay function 314.

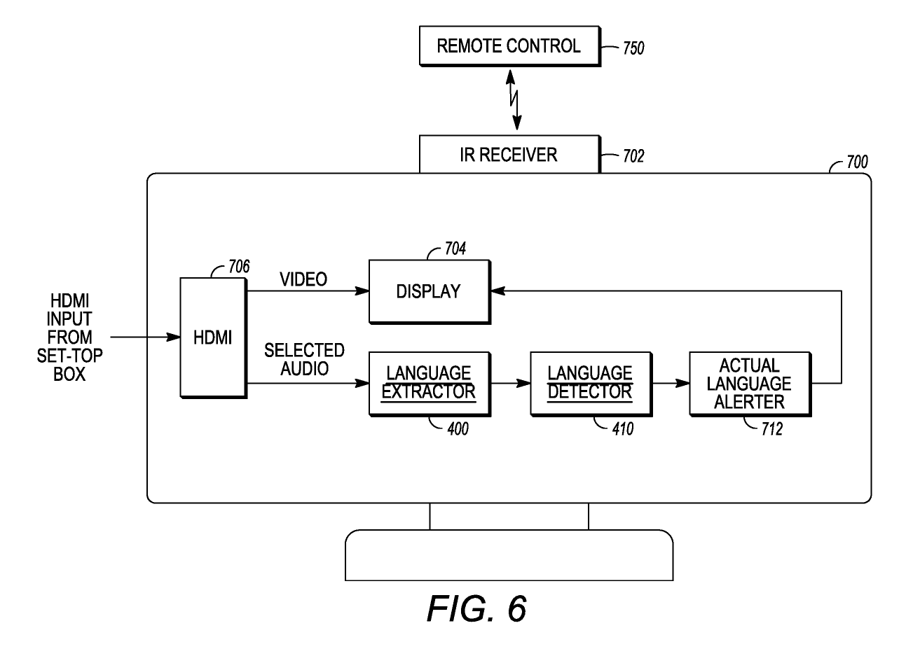

FIG. 6 shows an embodiment of an HDMI sink device such as a television including an actual language extractor and an actual language detector to alert a user of the HDMI sink device of an actual language being received, in accordance with the principles of the present invention.

In particular, as shown in FIG. 6, the language extractor 400 and language detector 410 may be implemented within an HDMI sink device such as a TV 700. In FIG. 6, a TV 700 is controlled by a standard remote control 750 via an appropriate infrared (IR) or RF receiver 702. The TV 700 includes a display 704, which is used by an actual language alert 712 to alert about a detected language within a selected audio stream. For instance, if the selected audio contains a soundtrack with French language being spoken, the language detector 410 would pass on the identity of French to the actual language alerter 712, which presents a visual alert on the display 704 at an appropriate time in an appropriate manner.

Though the present invention has been described in the context of English in a main audio channel and Spanish in a secondary audio channel since these are dominant languages in the United States, the present invention relates equally to any other language in the main audio channel and any other language in the secondary audio channel.

The disclosed embodiments are described with respect to implementation in a cable home device such as a DOSIS gateway device or set-top box. The invention is applicable for use in all countries, although obviously the secondary language will change depending upon the country of use. For any given expected language, the most frequent trigram (MFT) list will have to be generated and stored in a suitable trigram MFT list or database beforehand for use by the language detector module.

Moreover, while the disclosed embodiments are described with respect to operation within a set-top box, the present invention relates equally to operation in the cloud.

Although the embodiments disclosed herein are described with respect to use of AC-3 audio, the invention relates equally to use with any other compressed audio, using any appropriate descriptor. For instance, AAC audio with corresponding AAC descriptor could be used.

While the invention has been described with reference to MPEG-2 transport streams to carry audio and video as used in broadcast TV, the same approach to language detection can also be used with other multiplexing approaches such as MP4, which is widely used in over-the-top (OTT) services.

While the invention has been described with reference to the exemplary embodiments thereof, those skilled in the art will be able to make various modifications to the described embodiments of the invention without departing from the true spirit and scope of the invention.

What is claimed is:

1. A method of detecting an actual language contained within a digital audio stream within a compressed digital A/V stream, comprising:
monitoring the actual audio content of a currently selected audio stream within the MPEG-2 stream;
converting the monitored audio stream in real time to text;
generating a frequency of sequence of three letters (a trigram) in the converted text, and retaining a plurality of most frequent trigrams within the converted text; and
detecting an actual language being spoken in the digital audio stream by determining a closest match between the retained plurality of trigrams and a prestored entry in a list of most frequent trigrams (MFT) each pre-associated with a given respective language.

2. The method of detecting an actual language contained within a digital audio stream within a compressed digital A/V stream according to claim 1, wherein:
the compressed digital A/V stream is compressed using a lossy compression algorithm.

3. The method of detecting an actual language contained within a digital audio stream within a compressed digital A/V stream according to claim 2, wherein:
the compressed digital A/V stream is MPEG-2.

4. The method of detecting an actual language contained within a digital audio stream within a compressed digital A/V stream according to claim 2, wherein:
the compressed digital A/V stream is MP4.

5. The method of detecting an actual language contained within a digital audio stream within a compressed digital A/V stream according to claim 1, wherein:
the plurality of most frequent trigrams are retained for at least a fragment of a sentence within the text.

6. The method of detecting an actual language contained within a digital audio stream within a compressed digital A/V stream according to claim 1, further comprising:
recording the currently selected audio stream in a digital video recorder (DVR); and
storing in the DVR a program map table (PMT) with a new AC-3 descriptor for the detected language for use on a subsequent playback of the audio stream.

7. The method of detecting an actual language contained within a digital audio stream within a compressed digital A/V stream according to claim 1, further comprising:
comparing the detected language to an ISO language descriptor received in the MPEG-2 stream.

8. The method of detecting an actual language contained within a digital audio stream within a compressed digital A/V stream according to claim 1, wherein:
the method is initiated upon program transition of a video stream contained within the MPEG-2 stream.

9. The method of detecting an actual language contained within a digital audio stream within a compressed digital A/V stream according to claim 1, wherein:
the method is initiated upon a change of video stream contained within the MPEG-2 stream corresponding to a change of channel in a receiving device.

10. The method of detecting an actual language contained within a digital audio stream within a compressed digital A/V stream according to claim 1, wherein:
the frequency of sequence of three letter trigram is generated after fewer than 10 words are received.

11. The method of detecting an actual language contained within a digital audio stream within a compressed digital A/V stream according to claim 1, wherein:
the frequency of sequence of three letter trigram is generated after fewer than 3 words are received.

12. The method of detecting an actual language contained within a digital audio stream within a compressed digital A/V stream according to claim 1, further comprising:
alerting a receiving set-top box to the detected actual language being spoken in the currently selected audio stream.

13. The method of detecting an actual language contained within a digital audio stream within a compressed digital A/V stream according to claim 1, further comprising:
alerting a receiving HDMI sink device to the detected actual language being spoken in the currently selected audio stream.

14. A method of detecting an actual language contained within a digital audio stream within an HDMI stream, comprising:
monitoring the actual audio content of a currently selected audio stream within the HDMI stream;
converting the monitored audio stream in real time to text;
generating a frequency of sequence of three letters (a trigram) in the converted text, and retaining a plurality of most frequent trigrams within the converted text; and
detecting an actual language being spoken in the digital audio stream by determining a closest match between the retained plurality of trigrams and a prestored entry in a list of most frequent trigrams (MFT) each pre-associated with a given respective language.

15. The method of detecting an actual language contained within a digital audio stream within an HDMI stream according to claim 14, further comprising:
comparing the detected language to an ISO language descriptor received in the HDMI stream.

16. The method of detecting an actual language contained within a digital audio stream within an HDMI stream according to claim 14, wherein:
the method is initiated upon program transition of a video stream contained within the HDMI stream.

17. The method of detecting an actual language contained within a digital audio stream within an HDMI stream according to claim 14, wherein:
the method is initiated upon a change of video stream contained within the HDMI stream corresponding to a change of channel in an HDMI sink device.

18. The method of detecting an actual language contained within a digital audio stream within an HDMI stream according to claim 14, wherein:
the frequency of sequence of three letter trigram is generated after fewer than 5 words are received.

19. The method of detecting an actual language contained within a digital audio stream within an HDMI stream according to claim 14, further comprising:
alerting a receiving HDMI sink device to the detected actual language being spoken in the currently selected audio stream.

20. A method of detecting an actual language contained within a digital audio stream within a compressed digital A/V stream, comprising:
so extracting closed caption text from a video stream;
generating a frequency of sequence of three letters (a trigram) in the closed caption text, and retaining a plurality of most frequent trigrams within the closed caption text; and
detecting an actual language being spoken in the digital audio stream by determining a closest match between the retained plurality of trigrams and a prestored entry in a list of most frequent trigrams (MFT) each pre-associated with a given respective language.

21. A non-transitory computer-readable medium comprising instructions stored thereon for detecting an actual language contained within a digital audio stream within an HDMI stream, that when executed on a processor, performs the steps of:
monitoring the actual audio content of a currently selected audio stream within the HDMI stream;
converting the monitored audio stream in real time to text;
generating a frequency of sequence of three letters (a trigram) in the converted text, and retaining a plurality of most frequent trigrams within the converted text; and
detecting an actual language being spoken in the digital audio stream by determining a closest match between the retained plurality of trigrams and a prestored entry in a list of most frequent trigrams (MFT) each pre-associated with a given respective language.
